(19) United States
(12) Patent Application Publication
(10) Pub. No.: US 2009/0107973 A1
(43) Pub. Date: Apr. 30, 2009

(54) HEATING AND HEAT PRESERVATION COVER AND HEAT PRESERVATION COVER

(76) Inventor: Mei-Hsiang Pai, Kaohsiung County (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 12/204,062

(22) Filed: Sep. 4, 2008

(30) Foreign Application Priority Data
Oct. 25, 2007 (TW) 096217918

(51) Int. Cl. H05B 1/00; A47J 43/00

(52) U.S. Cl. 219/201; 99/645

(57) ABSTRACT

The invention relates to a heating and heat preservation cover and a heat preservation cover. The heating and heat preservation cover of the invention has a heat source device. The heat source device can provide heat to maintain the temperature and the quality of food disposed in the heating and heat preservation cover, to maintain the freshness and the tastiness of the food after cooking. Furthermore, the heating and heat preservation cover can avoid contact with and contamination from the outside, is foldable and portable, and can be easily received after being used so that its volume is reduced.

### BACKGROUND OF THE INVENTION

1. Field of the Invention

The present invention relates to a cover, and more particularly to a heating and heat preservation cover and a heat preservation cover.

2. Description of the Related Art

FIG. 1A is a schematic three-dimensional view of a conventional cover, and FIG. 1B is a schematic cross-sectional view of the conventional cover. Referring to FIGS. 1A and 1B, as a table cover for protecting food, the conventional cover 1 includes an annular body 11, a plurality of main ribs 12, a plurality of supporting ribs 13, a brace rod 14, and a yarn mesh 15. The annular body 11 has a through-hole 111, and one end of the main rib 12 is movably disposed around the annular body 11. One end of the supporting rib 13 is movably connected to a lower portion of the brace rod 14, and the other end is movably connected to a middle portion of the main rib 12. The brace rod 14 is opposite the through-hole 111 of the annular body 11 in the vertical direction. The yarn mesh 15 is attached to the main ribs 12, and each main rib 12 is spaced from the adjacent one by a distance.

The brace rod 14 is led by a wire 16 to pass through the through-hole 111 of the annular body 11, and accordingly the supporting ribs 13 drive the main ribs 12 to spread outward along a radial direction. The yarn mesh 15 is completely spread along with the main ribs 12, and thus, the conventional cover 1 is in the shape of an umbrella. The spread conventional cover 1 is used to cover and protect food or items on a table from being ruined by mosquitoes and flies. However, the conventional cover 1 cannot maintain the temperature of the food or items disposed therein, so it is impossible to maintain the edible quality of the food or the items. Further, if it turns cold after a period of time, the food or the item in the conventional cover 1 must be heated before eating, so the eating process becomes complicated, and the eating time is prolonged. Moreover, after the food or item is heated, the taste and the quality become quite different.

Therefore, it is necessary to provide a heating and heat preservation cover and a heat preservation cover to solve the above problems.

### SUMMARY OF THE INVENTION

The present invention is directed to a heating and heat preservation cover. The heating and heat preservation cover includes a pivot portion, a heat source device, and a cover portion. The pivot portion has at least one first joining portion. The heat source device is disposed on one end of the pivot portion. One end of each bracket has at least one second joining portion. The shape of the second joining portion matches that of the first joining portion, and the second joining portion moves along the first joining portion. An angle formed between an extension line of the two ends of the bracket and an axial extension line from the pivot portion to the heat source device is an acute angle. The cover portion is connected to the brackets.

Further, the present invention is directed to a heat preservation cover. The heat preservation cover includes a pivot portion and a plurality of blades. The pivot portion has a first joining portion. One end of each blade has at least one second joining portion. The shape of the second joining portion matches that of the first joining portion, and the second joining portion moves along the first joining portion. Therefore, by moving one of the blades, the other blades are driven to form a cover portion.

The heating and heat preservation cover or the heat preservation cover and a platform define an accommodation space for accommodating food or items. The heat source device can provide heat for the accommodation space, so as to maintain the temperature and the quality of the food or items disposed in the heating and heat preservation cover, maintain the freshness and the tastiness of the food or items after cooking, and avoid contact with and contamination from the outside.

In addition, since the heating and heat preservation cover can be flexibly folded, it is portable and can be easily received after being used, so that its volume is reduced.

### BRIEF DESCRIPTION OF THE DRAWINGS

FIG. 1A is a schematic three-dimensional view of a conventional cover;

FIG. 1B is a schematic cross-sectional view of the conventional cover;

FIG. 2A is a schematic view of a heating and heat preservation cover before being spread according to a first embodiment of the present invention;

FIG. 2B is a schematic view of the heating and heat preservation cover after being spread according to the first embodiment of the present invention;

FIG. 3 is a schematic view of a second aspect of the heating and heat preservation cover according to the first embodiment of the present invention;

FIG. 4 is a schematic view of a third aspect of the heating and heat preservation cover according to the first embodiment of the present invention;

FIG. 5 is a schematic view of the heating and heat preservation cover having bonding belts and bonding pads according to the first embodiment of the present invention;

FIG. 6A is a schematic view of a heating and heat preservation cover before being spread according to a second embodiment of the present invention;

FIG. 6B is a schematic view of the heating and heat preservation cover after being spread according to the second embodiment of the present invention;

FIG. 7A is a schematic view of a heat preservation cover before being spread according to the present invention;

FIG. 7B is a schematic view of a blade according to the heat preservation cover of the present invention;

FIG. 7C is a schematic view of the heat preservation cover after being spread according to the present invention; and

FIG. 8 is a schematic view of a heat preservation cover according to a third embodiment of the present invention.

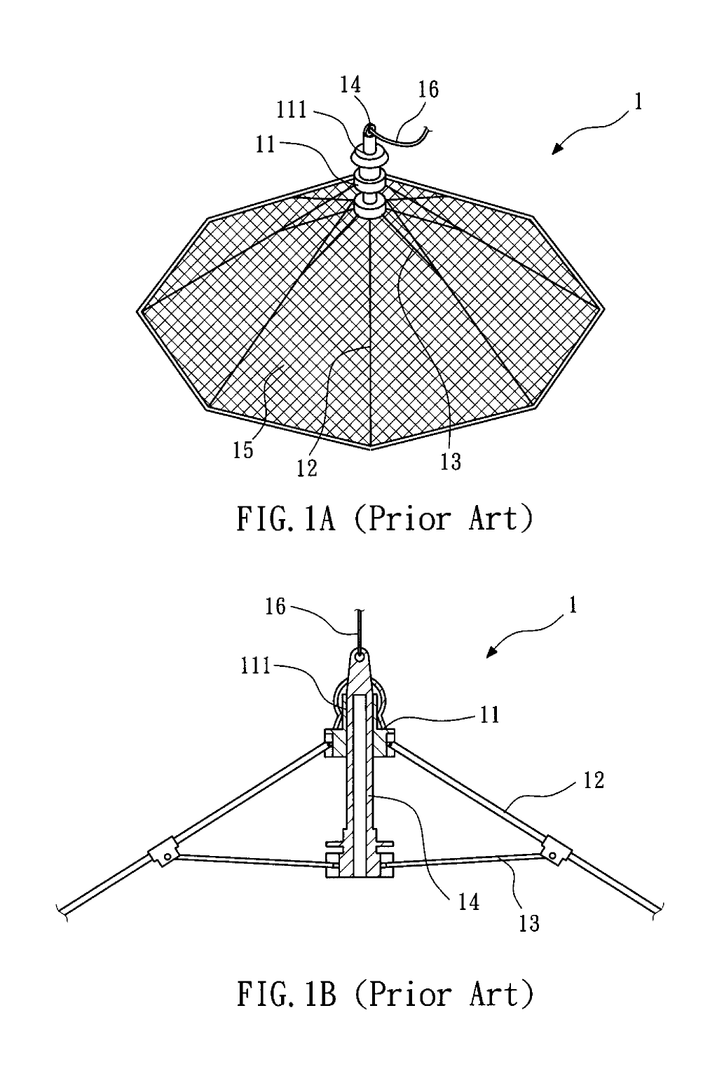

### DETAILED DESCRIPTION OF THE INVENTION

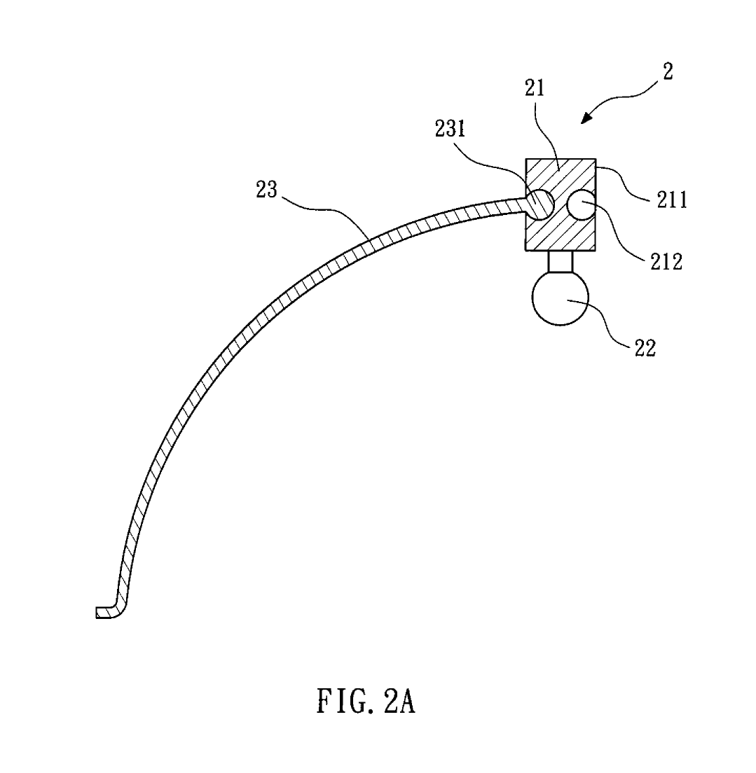

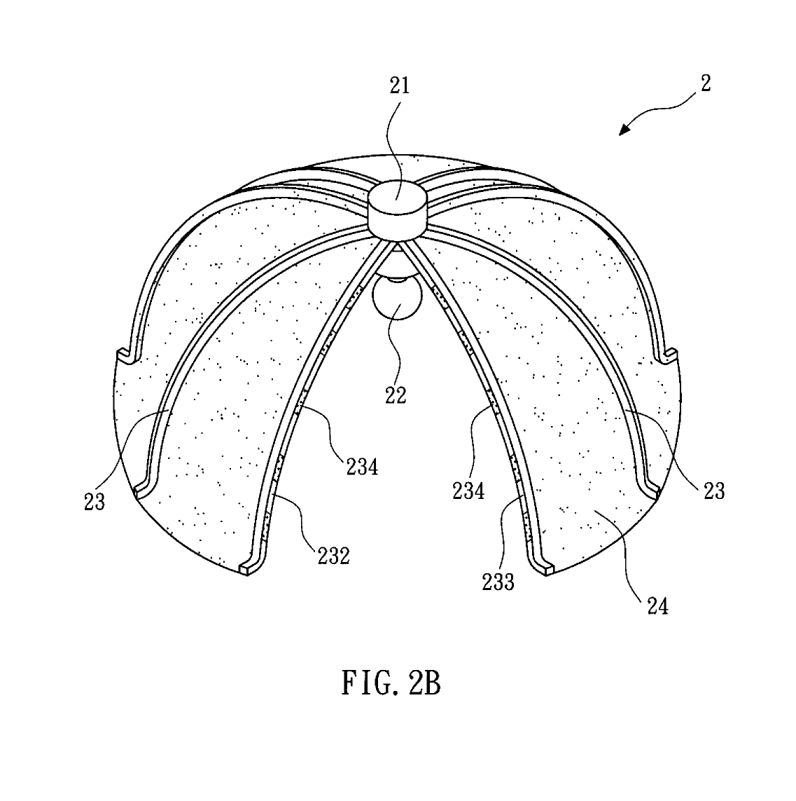

FIG. 2A is a schematic view of a heating and heat preservation cover before being spread according to a first embodiment of the present invention, and FIG. 2B is a schematic view of the heating and heat preservation cover after being spread according to the first embodiment of the present invention. Referring to FIGS. 2A and 2B, the heating and heat preservation cover 2 of the first embodiment includes a pivot portion 21, a heat source device 22, a plurality of brackets 23, and a cover portion 24. In this embodiment, the pivot portion 21 is a cylinder that a battery (not shown) could be disposed therein, so as to provide power for the heat source device 22, and the battery can be a rechargeable battery. In other applications, the pivot portion 21 has an external end connected to a power source and further electrically connected to the heat source device 22, so as to provide power for the heat source device 22. Moreover, the pivot portion 21 has a lateral side 211 and at least one first joining portion 212 located on the lateral side 211. The heat source device 22 is disposed on one end of the pivot portion 21, for supplying heat. The heat source device 22 is preferably a light source device (for example, a light bulb), and capable of selecting different powers in various applications. Alternatively, the heat source device 22 can be a heating device for generating heat, such as an infrared heating device, a ceramic heating device, or a hydrogen heating device.

One end of each bracket 23 has at least one second joining portion 231. The shape of the second joining portion 231 matches that of the first joining portion 212, and the second joining portion 231 moves along the first joining portion 212. An angle formed between an extension line of the two ends of the bracket 23 and an axial extension line from the pivot portion 21 to the heat source device 22 is an acute angle. In this embodiment, the bracket 23 further includes two bonding brackets 232 and 233 to be joined together.

The bracket 23 can be made of any material, for example, a metal or nonmetal material. The metal material includes stainless steel, elastic steel, iron, aluminum alloy, aluminum magnesium alloy, or other alloys. The nonmetal material includes wood, vine, bamboo, or a composite material thereof, or any plastic materials.

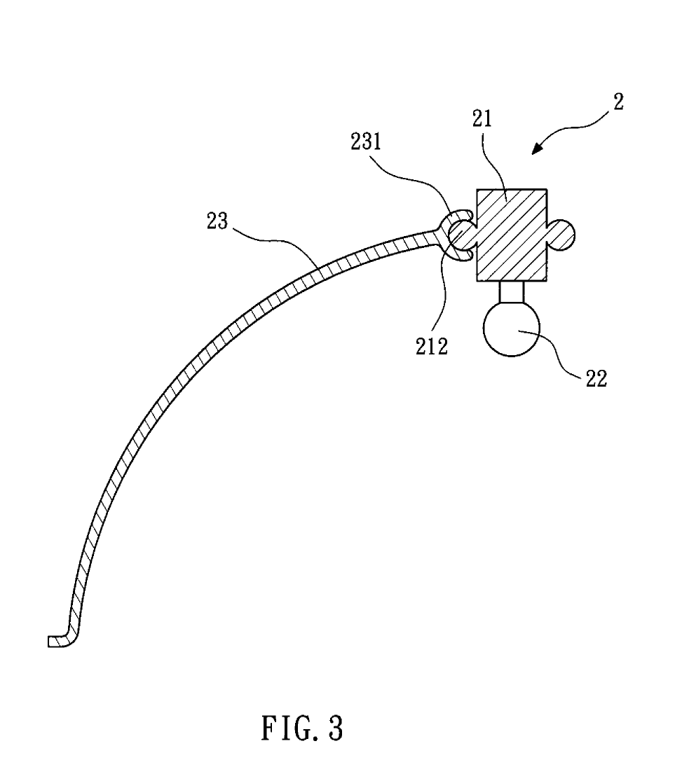

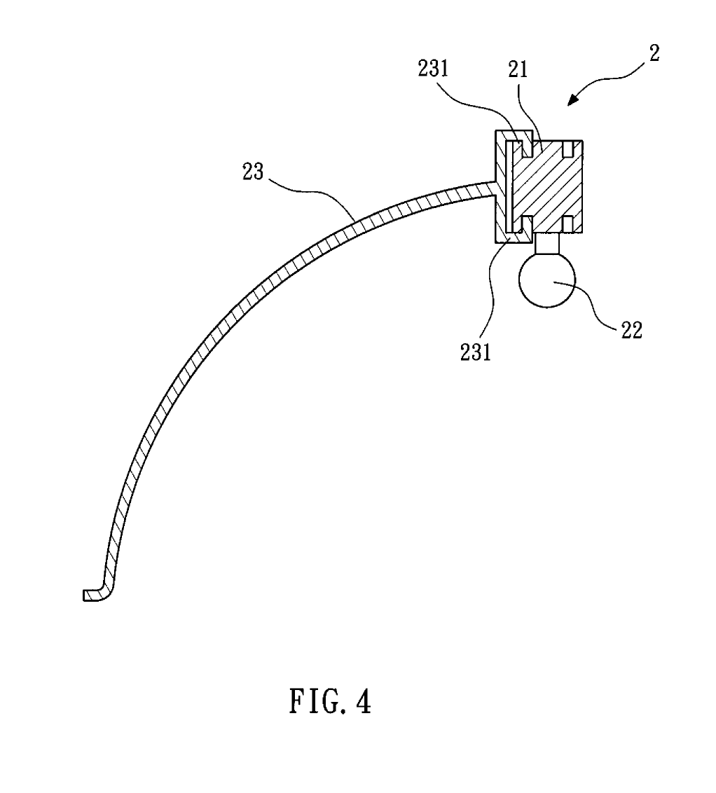

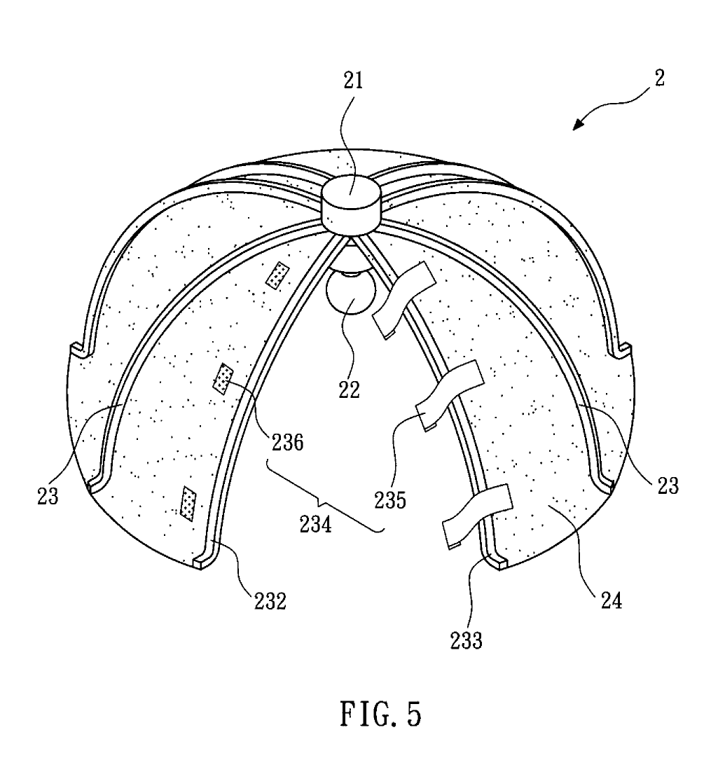

In this embodiment, the first joining portion 212 is an annular groove, and the second joining portion 231 is a neck structure caught in the annular groove, so that the brackets 23 can be movably spread along the annular groove. In other applications, the first joining portion 212 is an annular flange, and the second joining portion 231 is of a C-shaped structure. The C-shaped structure is caught on the annular flange (as shown in FIG. 3), and thus, the brackets 23 can be movably spread along the annular flange. Alternatively, the first joining portion 212 has two annular grooves respectively formed on two opposite end surfaces of the pivot portion 21, and the second joining portion 231 is a C-shaped hook. The two ends of the C-shaped hook are respectively caught in the annular grooves (as shown in FIG. 4), and thus, the brackets 23 can be movably spread along the annular grooves.

It should be noted that the first joining portion 212 is not limited to the above structures, and the first joining portion 212 and the second joining portion 231 can be of any structures capable of being movably joined to each other.

Referring to FIGS. 2A and 2B, preferably, opposite lateral sides of the bonding brackets 232 and 233 have bonding elements 234. In this embodiment, the bonding elements 234 are hook-and-loop fasteners, disposed on the opposite lateral sides of the bonding brackets 232 and 233 while spaced from each other, for connecting the bonding brackets 232 and 233, so as to fix and maintain the spread structure of the brackets 23 (i.e., an umbrella structure in this embodiment). In other applications, the bonding elements 234 can also be bar shaped, and attached to the opposite lateral sides of the bonding brackets 232 and 233. It should be noted that the bonding elements 234 can also be magnets or concave/convex buckle sets, and are not limited to the above configurations.

The cover portion 24 is connected to the bracket 23. In this embodiment, the cover portion 24 is disposed between the adjacent brackets 23 except the adjacent bonding brackets 232 and 233, and the cover portion 24 is disposed on an inner lateral side of the brackets 23. However, the cover portion 24 can also be disposed on an outer lateral side of the brackets 23 or penetrate the brackets 23. The cover portion 24 driven by the brackets 23 is spread like an umbrella, or is folded in the same way.

The cover portion 24 can be of a mesh structure. The cover portion 24 can also be made of cloth or other materials. Moreover, in different applications, the cover portion 24 can be made of a transparent material, such as high molecular polymer, so as to clearly see the state of items in the heating and heat preservation cover 2.

Referring to FIG. 5, in other applications, the bonding element 234 includes at least one bonding belt 235 and at least one bonding pad 236. One end of the bonding belt 235 is disposed on the surface of the cover portion 24 between the bonding bracket 233 and the adjacent bracket 23, the bonding pad 236 is disposed on the surface of the cover portion 24 between the bonding bracket 232 and the adjacent bracket 23, and the other end of the bonding belt is attached to the bonding pad. The opposite bonding elements 234 (the bonding belt 235 and the bonding pad 236) are matched and fixed to seal the heating and heat preservation cover 2. It should be noted that the bonding elements 234 can also be hook-and-loop fasteners, magnets, or concave/convex buckle sets, and are not limited to the above configurations.

The brackets 23 are spread, and the bonding brackets 232 and 233 are joined through the bonding elements, so that the heating and heat preservation cover 2 becomes an umbrella-shaped cover. The heating and heat preservation cover 2 and a platform (for example, a table top) define an accommodation space for accommodating food or items. The heat source device 22 provides heat for the accommodation space, so as to maintain the temperature and the quality of the food or items disposed in the heating and heat preservation cover 2, thus maintaining the freshness and tastiness of the food or items after cooking. Further, the heating and heat preservation cover 2 of the present invention can prevent mosquitoes or other insects from contaminating the food disposed therein.

It should be understood that the heating and heat preservation cover 2 of the present invention can be of different sizes. The heating and heat preservation cover with a smaller size can be applied to heat preservation and protection of food for an individual (for example, fried eggs, bread, take-away food, or small dishes of food), and the heating and heat preservation cover with a larger size can be applied to heat preservation and protection of food for several people (for example, a plurality of dishes).

In addition, one end of each bracket 23 is movably disposed on the lateral side 211 of the pivot portion 21, and the cover portion 24 disposed between the adjacent brackets 23 can be flexibly folded. Therefore, the heating and heat preservation cover is portable, and can be easily received after being used so that its volume is reduced.

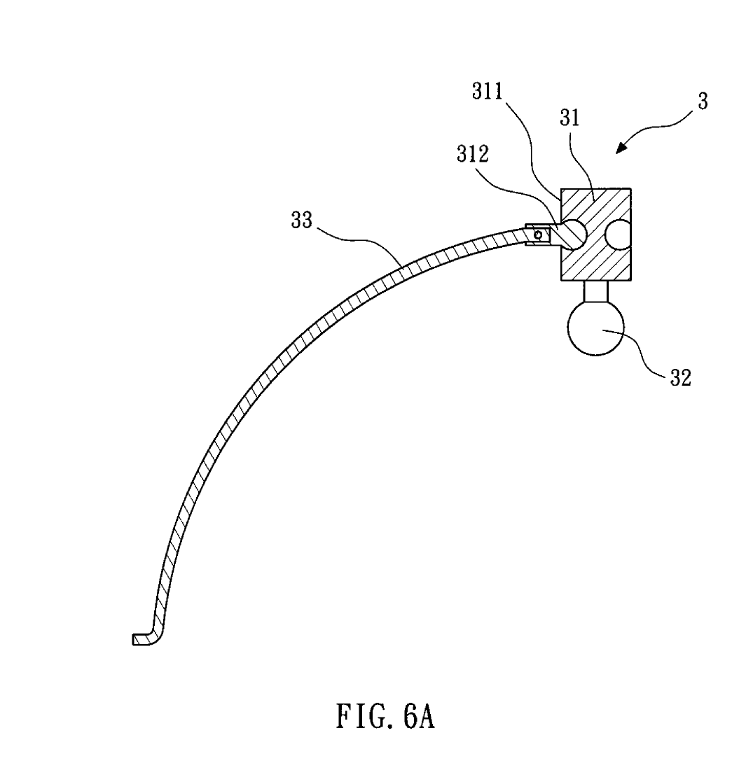

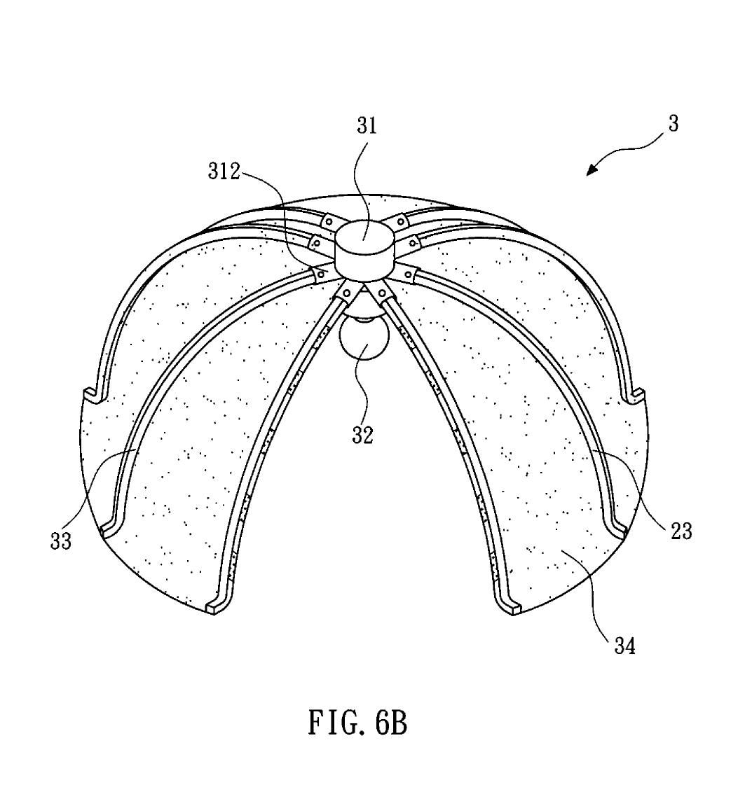

FIG. 6A is a schematic view of a heating and heat preservation cover before being spread according to a second embodiment of the present invention, and FIG. 6B is a schematic view of the heating and heat preservation cover after being spread according to the second embodiment of the present invention. Referring to FIGS. 6A and 6B, the heating and heat preservation cover 3 includes a pivot portion 31, a heat source device 32, a plurality of brackets 33, and a cover portion 34. The heating and heat preservation cover 3 of the second embodiment is different from the heating and heat preservation cover 2 of the first embodiment in FIGS. 2A and 2B in the following aspect. A lateral side 311 of the pivot portion 31 in the heating and heat preservation cover 3 of the second embodiment has a plurality of movable connecting elements 312, and one end of each bracket 33 is connected to a corresponding movable connecting element 312. In this embodiment, one end of each bracket 33 is connected to the corresponding movable connecting element 312 by bolting, but is not limited thereto. The rest of the means in the heating and heat preservation cover 3 of the second embodiment are identical to those in the heating and heat preservation cover 2 of the first embodiment, so the details will not be given herein again.

Similarly, the heating and heat preservation cover 3 of the second embodiment can also maintain the temperature and the quality of food or items disposed therein, maintain the freshness and the tastiness of the food or items, and avoid contact with and contamination from the outside. Moreover, the heating and heat preservation cover 3 is portable, and can be easily received after being used so that its volume is reduced.

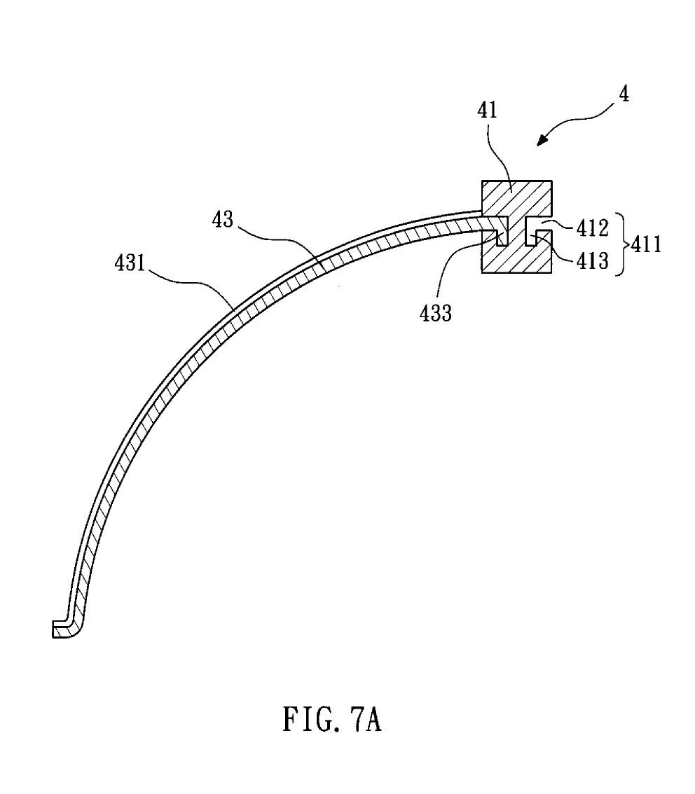

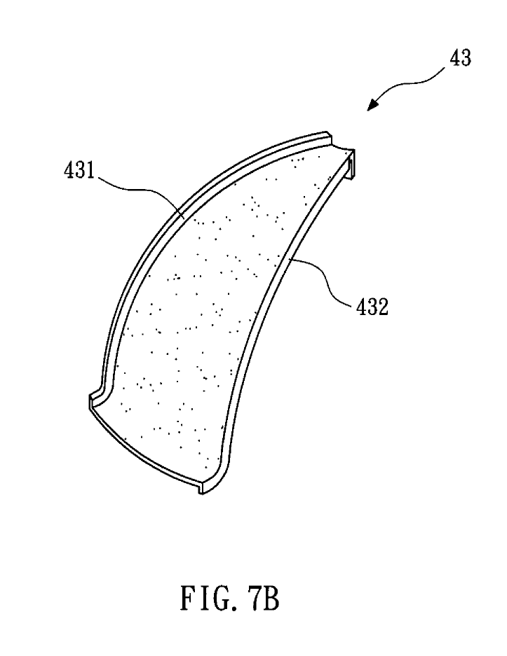

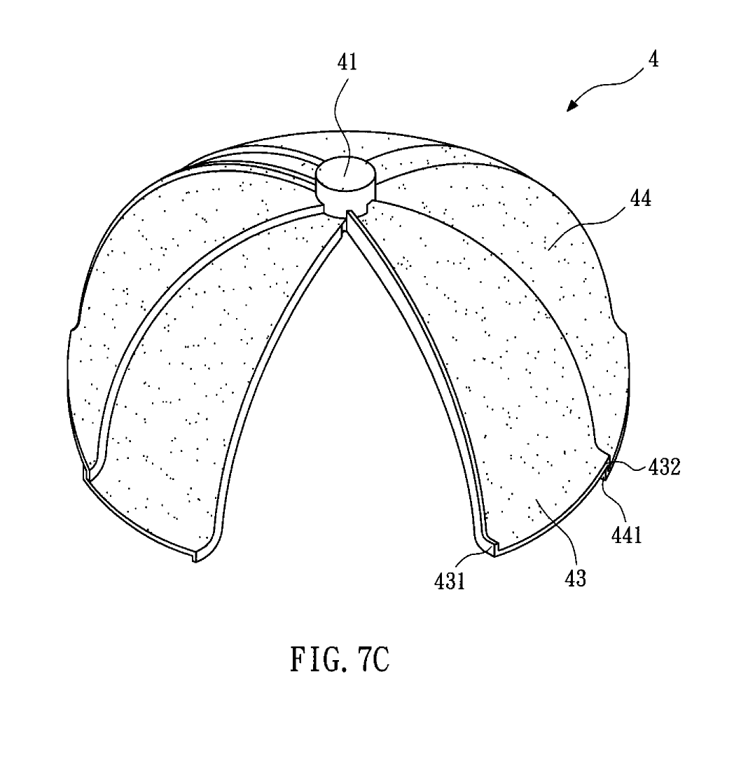

FIG. 7A is a schematic view of a heat preservation cover before being spread according to the present invention, FIG. 7B is a schematic view of a blade according to the heat preservation cover of the present invention, and FIG. 7C is a schematic view of the heat preservation cover after being spread according to the present invention. Referring to FIGS. 7A to 7C, the heat preservation cover 4 at least includes a pivot portion 41 and a plurality of blades 43. In this embodiment, the pivot portion 41 has a first joining portion 411 having a radial annular slot 412 and an axial annular slot 413, and each blade 43 has at least one second joining portion 433. The shape of the second joining portion 433 matches that of the first joining portion 411, and the second joining portion 433 moves along the first joining portion 411.

Each blade has an upper protruding edge and a lower protruding edge, for example, the blade 43 has an upper protruding edge 431 and a lower protruding edge 432, wherein the upper protruding edge and the lower protruding edge of each blade are located by two corresponding edges and along an end of each blade to the other end. By moving one of the blades, the other blades are driven to form a cover portion. For example, in FIG. 7C, the lower protruding edge 432 of the blade 43 can hook the upper protruding edge 441 of the adjacent blade 44, so does it apply to the rest of the blades. Therefore, by moving the blade 43, the blades 43, 44 and the others are driven to form a cover portion by dragging the corresponding lower protruding edge (the lower protruding edge 432) and upper protruding edge (the upper protruding edge 441) of the adjacent blades.

In various applications, the first joining portion can be an annular groove, and the second joining portion is a neck structure caught in the annular groove (referring to FIG. 2A); the first joining portion can be an annular flange, and the second joining portion is a C-shaped structure caught on the annular flange (referring to FIG. 3); or the first joining portion can have two annular grooves respectively formed on two opposite end surfaces of the pivot portion, and the second joining portion is a C-shaped hook with two ends respectively caught in the annular grooves (referring to FIG. 4).

The heat preservation cover 4 of the present invention can maintain the temperature and the quality of food or items disposed therein to maintain the freshness and the tastiness of the food or items, and avoid contact with and contamination from the outside to protect the food or items disposed therein. In addition, the heat preservation cover 4 of the present invention has simple structure, and can be easily spread to form a cover portion and received after being used, so that its volume is reduced and it is portable.

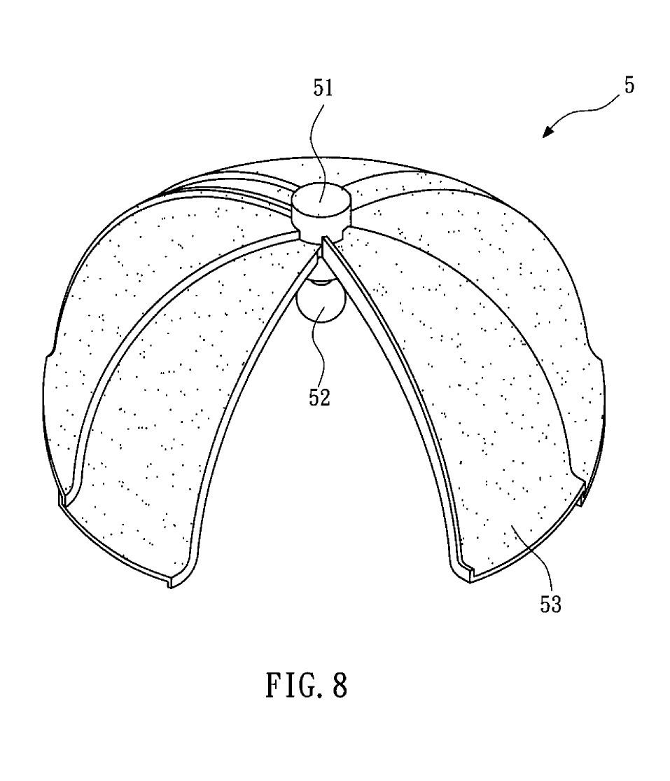

FIG. 8 is a schematic view of a heat preservation cover according to a third embodiment of the present invention. In the third embodiment, the heat preservation cover 5 includes a pivot portion 51 and a plurality of blades 53, and further includes a heat source device 52 disposed on one end of the pivot portion 51, so it becomes a heating and heat preservation cover. The pivot portion 51 and the blades 53 in the heat preservation cover 5 are identical to those in the heat preservation cover 4 in FIG. 7C, and the heat source device 52 in the heat preservation cover 5 is identical to that in the heating and heat preservation cover 2, so the details will not be given herein again.

Therefore, the heat preservation cover 5 having the heat source device 52 according to the third embodiment of the present invention can not only avoid contact with and contamination from the outside but also maintain the temperature and the quality of food or items disposed therein to maintain the freshness and the tastiness of the food or items.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. A heating and heat preservation cover, comprising:
a pivot portion, having at least one first joining portion;
a heat source device, disposed on one end of the pivot portion;
a plurality of brackets, wherein one end of each bracket has at least one second joining portion, the shape of the second joining portion matches that of the first joining portion, the second joining portion moves along the first joining portion, and an angle formed between an extension line of the two ends of the bracket and an axial extension line from the pivot portion to the heat source device is an acute angle; and
a cover portion, connected to the brackets.

2. The heating and heat preservation cover according to claim 1, wherein a battery is disposed in the pivot portion, so as to provide power for the heat source device.

3. The heating and heat preservation cover according to claim 2, wherein the battery is a rechargeable battery.

4. The heating and heat preservation cover according to claim 1, wherein the pivot portion has an external end connected to a power source and further electrically connected to the heat source device.

5. The heating and heat preservation cover according to claim 1, wherein the first joining portion is an annular groove, and the second joining portion is a neck structure caught in the annular groove.

6. The heating and heat preservation cover according to claim 1, wherein the first joining portion is an annular flange, and the second joining portion is a C-shaped structure caught on the annular flange.

7. The heating and heat preservation cover according to claim 1, wherein the first joining portion has two annular grooves respectively formed on two opposite end surfaces of the pivot portion, and the second joining portion is a C-shaped hook with two ends respectively caught in the annular grooves.

8. The heating and heat preservation cover according to claim 1, wherein a lateral side of the pivot portion has a plurality of movable connecting elements, and one end of each bracket is connected to the corresponding movable connecting element.

9. The heating and heat preservation cover according to claim 8, wherein one end of each bracket is connected to the corresponding movable connecting element by bolting.

10. The heating and heat preservation cover according to claim 1, wherein the bracket comprises two bonding brackets, and opposite lateral sides of the bonding brackets have bonding elements so as to connect the bonding brackets.

11. The heating and heat preservation cover according to claim 10, wherein the cover portion is not disposed between the bonding brackets.

12. The heating and heat preservation cover according to claim 10, wherein the bonding elements are hook-and-loop fasteners.

13. The heating and heat preservation cover according to claim 10, wherein the bonding elements are magnets.

14. The heating and heat preservation cover according to claim 10, wherein the bonding elements are concave/convex buckle sets.

15. The heating and heat preservation cover according to claim 1, wherein the bracket is made of a metal or nonmetal material.

16. The heating and heat preservation cover according to claim 15, wherein the metal material comprises stainless steel, elastic steel, iron, aluminum alloy, aluminum magnesium alloy, or other alloys.

17. The heating and heat preservation cover according to claim 15, wherein the nonmetal material comprises any plastic materials.

18. The heating and heat preservation cover according to claim 15, wherein the nonmetal material comprises wood, vine, bamboo, or a composite material thereof.

19. The heating and heat preservation cover according to claim 1, wherein the heat source device is a light source device.

20. The heating and heat preservation cover according to claim 19, wherein the light source device is a light bulb.

21. The heating and heat preservation cover according to claim 1, wherein the heat source device is a heating device.

22. The heating and heat preservation cover according to claim 21, wherein the heating device is an infrared heating device.

23. The heating and heat preservation cover according to claim 21, wherein the heating device is a ceramic heating device.

24. The heating and heat preservation cover according to claim 21, wherein the heating device is a hydrogen heating device.

25. The heating and heat preservation cover according to claim 1, wherein the cover portion is of a mesh structure.

26. The heating and heat preservation cover according to claim 1, wherein the cover portion is made of cloth.

27. The heating and heat preservation cover according to claim 1, wherein the cover portion is made of a transparent material.

28. The heating and heat preservation cover according to claim 27, wherein the cover portion is made of a high molecular polymer.

29. The heating and heat preservation cover according to claim 1, wherein the bracket comprises two bonding brackets, and at least one set of bonding elements is disposed on the surface of the cover portion, the set of bonding elements comprises a bonding belt and a bonding pad, one end of the bonding belt is disposed on the surface of the cover portion between one bonding bracket and an adjacent bracket, the bonding pad is disposed on the surface of the cover portion between another bonding bracket and an adjacent bracket, and the other end of the bonding belt is attached to the bonding pad.

30. A heat preservation cover, comprising:
a pivot portion, having a first joining portion; and
a plurality of blades, wherein one end of each blade has at least one second joining portion, the shape of the second joining portion matches that of the first joining portion, the second joining portion moves along the first joining portion, and by moving one of the blades, the other blades are driven to form a cover portion.

31. The heat preservation cover according to claim 30, wherein the first joining portion has a radial annular slot and an axial annular slot.

32. The heat preservation cover according to claim 30, wherein each blade further has an upper protruding edge and a lower protruding edge, the upper protruding edge and the lower protruding edge of the blade are located by two corresponding edges and along the end of each blade to the other end, and by moving one of the blades, the blades are driven to form the cover portion by dragging the corresponding upper protruding edge and lower protruding edge of the adjacent blades.

33. The heat preservation cover according to claim 30, wherein the first joining portion is an annular groove, and the second joining portion is a neck structure caught in the annular groove.

34. The heat preservation cover according to claim 30, wherein the first joining portion is an annular flange, and the second joining portion is a C-shaped structure caught on the annular flange.

35. The heat preservation cover according to claim 30, wherein the first joining portion has two annular grooves respectively formed on two opposite end surfaces of the pivot portion, and the second joining portion is a C-shaped hook with two ends respectively caught in the annular grooves.

36. The heat preservation cover according to claim 30, wherein the blade is made of a metal or nonmetal material.

37. The heat preservation cover according to claim 36, wherein the is metal material comprises stainless steel, elastic steel, iron, aluminum alloy, aluminum magnesium alloy, or other alloys.

38. The heat preservation cover according to claim 36, wherein the nonmetal material comprises any plastic materials.

39. The heat preservation cover according to claim 30, further comprising a heat source device disposed on one end of the pivot portion.

40. The heat preservation cover according to claim 39, wherein a battery is disposed in the pivot portion, so as to provide power for the heat source device.

41. The heat preservation cover according to claim 40, wherein the battery is a rechargeable battery.

42. The heat preservation cover according to claim 39, wherein the pivot portion has an external end connected to a power source and further electrically connected to the heat source device.

43. The heat preservation cover according to claim 39, wherein the heat source device is a light source device.

44. The heat preservation cover according to claim 43, wherein the light source device is a light bulb.

45. The heat preservation cover according to claim 39, wherein the heat source device is a heating device.

46. The heat preservation cover according to claim 45, wherein the heating device is an infrared heating device.

47. The heat preservation cover according to claim 45, wherein the heating device is a ceramic heating device.

48. The heat preservation cover according to claim 45, wherein the heating device is a hydrogen heating device.
